(19) United States
(12) Patent Application Publication
(10) Pub. No.: US 2022/0369431 A1
(43) Pub. Date: Nov. 17, 2022

(54) METHOD FOR CONTROLLING AN INDUCTION COOKING HOB

(71) Applicant: ELECTROLUX APPLIANCES AKTIEBOLAG, Stockholm (SE)

(72) Inventors: Alex VIROLI, Forli (IT); Massimo NOSTRO, Forli (IT); Massimo ZANGOLI, Forli (IT); Filippo MILANESI, Forli (IT); Fabio ANGELI, Forli (IT); Svend Erik CHRISTIANSEN, Forli (IT)

(21) Appl. No.: 17/623,965

(22) PCT Filed: Jun. 26, 2020
(86) PCT No.: PCT/EP2020/067985

§ 371 Date: Dec. 30, 2021

(30) Foreign Application Priority Data
Jul. 12, 2019 (EP) 19185902.4

(51) Int. Cl. H05B 6/06

(52) U.S. Cl. CPC H05B 6/062

(57) ABSTRACT

The present invention relates to a method for controlling an induction cooking hob, wherein said method comprises an operation mode for estimating the energy efficiency (EE), and wherein said operation mode includes the steps of: a) estimating (12) the dissipated electric energy (ED) of the induction cooking hob, b) comparing (14) the dissipated electric energy (ED) with a threshold value (EDthr) for said dissipated electric energy (ED), c) maintaining (16) the current working parameters of the induction cooking hob, if the dissipated electric energy (ED) is not bigger than the threshold value (EDthr), d) changing (18) the current working parameters, if the dissipated electric energy (ED) is bigger than the threshold value (EDthr), and e) repeating the steps a) and b) and then c) or d), respectively, after a predetermined time period.

The present invention relates to a method for controlling an induction cooking hob. Further, the present invention relates to an induction cooking hob adapted for performing said method.

An induction cooking hob comprises one or more induction coils, at least one induction generator and a control unit. The induction generator provides the induction coils with alternating current. The control unit adjusts the working parameters of the induction generator. Usually, the control unit estimates the power transferred to the induction coils. Sometimes, the control unit determines frequencies for the induction coils in order to avoid acoustic noise. Moreover, the control unit may select working parameters for protecting the electric and electronic components. Further, the control unit may be provided for performing an operation mode for a very fast heating.

It is an object of the present invention to provide a method for controlling an induction cooking hob, which optimises the energy efficiency of said induction cooking hob.

The object is achieved by the method according to claim 1.

According to the present invention a method for controlling an induction cooking hob is provided, wherein said method comprises an operation mode for estimating the energy efficiency EE, and wherein said operation mode includes the steps of:
a) estimating the dissipated electric energy ED of the induction cooking hob,
b) comparing the dissipated electric energy ED with a threshold value EDthr for said dissipated electric energy ED,
c) maintaining the current working parameters of the induction cooking hob, if the dissipated electric energy ED is not bigger than the threshold value EDthr,
d) changing the current working parameters, if the dissipated electric energy ED is bigger than the threshold value EDthr, and
e) repeating the steps a) and b) and then c) or d), respectively, after a predetermined time period.

The operation mode for estimating the energy efficiency EE allows a dynamic adaption of the working conditions of the induction cooking hob, so that an optimised energy efficiency EE is obtained. The user can decide, if the energy efficiency EE is increased, while possibly the cooking speed is reduced and the cooking time is elongated.

Preferably, the operation mode for estimating the energy efficiency EE is activated or activatable by the user.

For example, the time period in step e) mentioned above is between five seconds and twenty seconds, preferably ten seconds.

In particular, the energy efficiency EE is given by the relationship

EE=EP/EI,

wherein EP is the electric energy transferred to a cooking pot arranged on the induction cooking hob and EI is the electric energy provided by the mains supply.

Further, the electric energy EI provided by the mains supply

EI=EP+ED

may be composed of the electric energy EP transferred to the cooking pot and a dissipated electric energy ED.

The dissipated electric energy ED may be consumed by switching elements, induction coils and cooling fans. The switching elements are electronic switches, in particular power transistors, that are used to drive the induction coils with current at the desired frequency, for example in the range of 18 kHz up to 100 kHz.

Preferably, the dissipated electric energy ED is estimated from detected parameters of the cooling fan, induction generator and induction coil.

In particular, the dissipated electric energy ED is estimated from the voltage, current and/or power of the cooling fan, induction generator and induction coil.

Moreover, the dissipated electric energy ED may be estimated from detected temperatures of the cooking pot, induction coils and/or electronic components.

Furthermore, the relationships between the dissipated electric energy ED and detectable working parameters are stored as software in a memory of a control unit of the induction cooking hob.

For example, the relationships between the dissipated electric energy ED and detectable working parameters of the induction cooking hob are stored as tables and/or mathematical functions.

In particular, the relationships between the dissipated electric energy ED and detectable working parameters of the induction cooking hob are obtained from experiments in a lab.

Further, the present invention relates to an induction cooking hob, wherein said induction cooking hob is controlled or controllable by the method mentioned above.

At last, the present invention relates to a computer program product stored on a computer usable medium, comprising computer readable program means for causing a computer to perform the method described above.

Novel and inventive features of the present invention are set forth in the appended claims.

The present invention will be described in further detail with reference to the drawing, in which

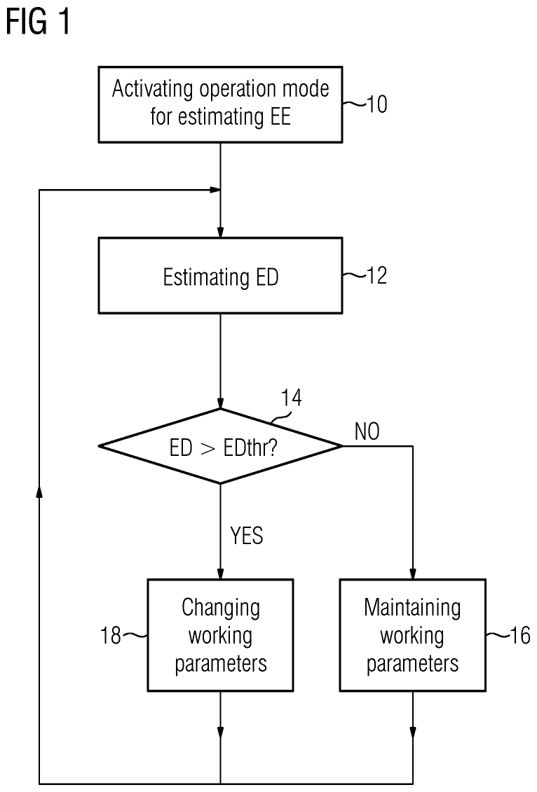

FIG. 1 illustrates a schematic flow chart diagram of an operation mode for estimating the energy efficiency of an induction cooking hob according to a preferred embodiment of the present invention.

FIG. 1 illustrates a schematic flow chart diagram of an operation mode for estimating the energy efficiency EE of an induction cooking hob according to a preferred embodiment of the present invention.

Preferably, the operation mode for estimating the energy efficiency EE is a part of a method for controlling the induction cooking hob. For example, said operation mode for estimating the energy efficiency EE is activated by a user of the induction cooking hob. The operation mode for estimating the energy efficiency EE as well as the method for controlling the induction cooking hob are controlled by at least one control unit of the induction cooking hob. For example, the operation mode for estimating the energy efficiency EE is supported by software of the control unit.

The energy efficiency EE is given by the relationship

EE=EP/EI,

wherein EP is the electric energy transferred to a cooking pot arranged on the induction cooking hob and EI is the electric energy provided by the mains supply. The value of the energy efficiency EE is between zero and one. It is desired that the energy efficiency EE is as large as possible.

The electric energy EI provided by the mains supply

EI=EP+ED

is composed of the electric energy EP transferred to the cooking pot and a dissipated electric energy ED. For example, the dissipated electric energy ED is consumed by switching elements, induction coils and cooling fans.

In a first step 10, the operation mode for estimating the energy efficiency EE is activated by the user of the induction cooking hob.

In a next step 12, the dissipated electric energy ED is estimated. In particular, electric energy ED is dissipated in the switching elements of the induction generator, by cooling fans and in the induction coils. The dissipated electric energy ED is indirectly estimated by detecting parameters like voltage, current and/or power of the cooling fan, induction generator and induction coil and temperatures of the cookware, induction coils and/or electronic components. The relationships between the dissipated electric energy ED and the detectable parameters are stored as in the software of the control unit, e.g. as tables or mathematical functions. Said relationships may be experimentally determined in a lab.

In a further step 14, the dissipated electric energy ED is compared with a threshold value EDthr for the dissipated electric energy ED. Said threshold value EDthr is defined in such a way that a certain desired level of energy efficiency EE is obtained.

If the dissipated electric energy ED is not bigger than the threshold value EDthr for said dissipated electric energy, then the control unit does not perform any action in step 16, i.e. the working parameters of the induction generator are maintained.

However, if the dissipated electric energy ED is bigger than the threshold value EDthr for said dissipated electric energy, then the control unit acts on one or more working parameters of the induction generator in step 18, i.e. the working parameters of the induction generator are changed. For example, the estimated power transfer to the induction coil is reduced.

At last, step 12 of estimating the dissipated electric energy ED and step 14 of comparing said dissipated electric energy ED with the threshold value EDthr are periodically repeated. For example, the periods between subsequent repetitions are between five seconds and twenty seconds, preferably about ten seconds. By this way, the threshold value EDthr for the dissipated electric energy ED is not exceeded for a longer time interval. At most, the threshold value EDthr for the dissipated electric energy ED is exceeded for a few seconds.

The operation mode for estimating the energy efficiency EE according to the present invention allows a dynamic adaption of the working conditions of the induction cooking hob. For example, the switching frequency of the induction generator or the power transfer to the cooking pot are dynamically changed and adapted.

The present invention allows an optimised energy efficiency EE, while possibly the cooking speed is reduced. The user can decide, if the energy efficiency EE is increased, while possibly the cooking time is elongated.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 step of activating the operation mode for estimating the energy efficiency EE
12 step of estimating the dissipated electric energy ED
14 step of comparing the dissipated electric energy ED with the threshold value EDthr
16 step of maintaining the current working parameters
18 step of changing the current working parameters
EI electric energy provided by the mains
EP electric energy transferred to the cooking pot
ED dissipated electric energy
EDthr threshold value for the dissipated electric energy
EE energy efficiency

1. A method for controlling an induction cooking hob, comprising an operation mode for estimating energy efficiency EE that includes the steps of:
a) estimating dissipated electric energy ED of the induction cooking hob,
b) comparing the dissipated electric energy ED with a threshold value EDthr for said dissipated electric energy ED,
c) maintaining current working parameters of the induction cooking hob if the dissipated electric energy ED is not bigger than the threshold value EDthr,
d) changing the current working parameters if the dissipated electric energy ED is bigger than the threshold value EDthr, and
e) repeating the steps a) and b) and then c) or d), respectively, after a predetermined time period.

2. The method according to claim 1,
wherein
the operation mode for estimating the energy efficiency EE is activated or activatable by a user.

3. The method according to claim 1,
wherein
the time period is between five seconds and twenty seconds.

4. The method according to claim 1,
wherein
the energy efficiency EE is given by the relationship
EE=EP/EI,
wherein EP is electric energy transferred to a cooking pot arranged on the induction cooking hob and EI is electric energy provided by a mains supply for the induction cooking hob.

5. The method according to claim 4,
wherein
the electric energy EI provided by the mains supply is composed of the electric energy EP transferred to the cooking pot and the dissipated electric energy ED and thereby satisfies the expression EI=EP+ED.

6. The method according to claim 5,
wherein
the dissipated electric energy ED is consumed by switching elements, induction coils and cooling fans.

7. The method according to claim 1,
wherein
the dissipated electric energy ED is estimated from detected parameters of the cooling fan, induction generator and induction coil.

8. The method according to claim 7,
wherein
the dissipated electric energy ED is estimated from a voltage, current and/or power of the cooling fan, induction generator and induction coil.

9. The method according to claim 1,
wherein
the dissipated electric energy ED is estimated from detected temperatures of the cooking pot, induction coils and/or electronic components.

10. The method according to claim 1,
wherein
relationships between the dissipated electric energy ED and detectable working parameters are stored as software in a memory of a control unit of the induction cooking hob.

11. The method according to claim 1,
wherein
relationships between the dissipated electric energy ED and detectable working parameters of the induction cooking hob are stored as tables and/or mathematical functions.

12. The method according to claim 1,
wherein
relationships between the dissipated electric energy ED and detectable working parameters of the induction cooking hob are obtained from experiments in a lab.

13. An induction cooking hob, configured to be
controlled or controllable by the method according to claim 1.

14. A computer-storage medium, comprising computer readable instructions that, when executed by a computer, will cause the computer to perform the method according to claim 1.

15. An induction cooking hob comprising:
an induction coil adapted to transfer cooking energy to a cooking pot when placed above the induction coil;
an induction generator configured to supply power to the induction coil; and
a controller configured to operates the cooking hob, including said induction generator, according to a set of work parameters to execute a cooking operation, said controller being further configured to receive a user instruction to activate an energy-efficient operating mode during said cooking operation wherein upon activation of said mode said controller is configured to:
a) estimate an energy efficiency of the cooking hob by evaluating one or more sensed parameters during said cooking operation, the sensed parameters comprising one or more of the following: voltage, current and/or power of a cooling fan of the cooking hob; voltage, current and/or power of the induction generator; voltage, current and/or power of the induction coil; temperature of the cooking pot being heated over the induction coil; temperature of other electronic components of the cooking hob;
b) compare the estimated energy efficiency with a threshold value of energy efficiency;
c) if the estimated energy efficiency is greater than said threshold value, then maintain said working parameters for said cooking operation;
d) if the estimated energy efficiency is lower than said threshold value, then adjust said working parameters so that the estimated energy efficiency will exceed the threshold value; and
e) repeat steps (a)-(d) periodically in order to dynamically adapt said working parameters to thereby enhance energy efficiency of the cooking hob;
wherein relationships between said estimated energy efficiency and said sensed parameters are stored in tables accessible by said controller or in software executable by the controller.

16. The induction cooking hob according to claim 15, said working parameters comprising one or more of: a switching frequency of the induction generator, energy transfer to the induction coil
